(19) United States
(12) Patent Application Publication
(10) Pub. No.: US 2010/0013652 A1
(43) Pub. Date: Jan. 21, 2010

(54) SHAKE RESPONSIVE MEDIA PLAYER

(75) Inventors: Chuan-Hong Wang, Tu-Cheng (TW); Li-Zhang Huang, Tu-Cheng (TW); Te-Yuan Kung, Tu-Cheng (TW); Tsu-Li Chiang, Tu-Cheng (TW); Xiao-Guang Li, Shenzhen City (CN); Kuan-Hong Hsieh, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/427,699

(22) Filed: Apr. 21, 2009

(30) Foreign Application Priority Data
Jul. 21, 2008 (CN) 200810302866.2

(51) Int. Cl. G08B 21/00; G06F 17/00

(52) U.S. Cl. 340/669; 700/94

(57) ABSTRACT

A shake responsive media player is provided. The media player comprises, a motion sensor, a storage unit, a motion state determining unit, a media file determining unit, and a processing unit. The motion sensor is used for detecting a shaking motion imparted to the media player by a user. The storage unit stores at least one group of media files associated with each other having same contents and different sampling rates and a table defining relationships between shaking levels of the shaking motion and the sampling rates of the at least one group of media files. The motion state determines one of the shaking levels of the media player according to signals from the motion sensing unit. The a media file determining unit, when a first media file of the at least one group of media files is playing, determines a second media file associated with the first media file having the sampling rate corresponding to the shaking level determined by the motion state determining unit according to the table.

### RELATED APPLICATIONS

This application is related to U.S. patent application with an Attorney Docket Number of US15558 and a title of SHAKE RESPONSIVE MEDIA PLAYER, which has the same assignee as the current application and has been concurrently filed.

### BACKGROUND

1. Technical Field

The present disclosure relates to media players, and more particularly to a shake responsive media player.

2. Description of Related Art

Electronic Media Players have become popular personal entertainment devices due to their highly portable nature. Many portable electronic devices such as cellular telephones and personal digital assistants (PDAs) include the ability to play electronic music media in many of the most commonly available file formats including MP3, AVI, WAV, MPG, QT, WMA, AIFF, AU, RAM, RA, MOV, MIDI, etc.

The portable media players of the relevant art enable users to listen to music as digital audio files and/or as part of digital video files, by selecting media items from memory and playing the media files such that the audio content can be listened to through headphones or speakers. Such listening activities however are entirely passive, relegating the user to being a listener of the music content but do not provide more fun to the users. Therefore, there is a need to provide a media player that can provide more fun to the users.

### BRIEF DESCRIPTION OF THE DRAWINGS

FIG. 1 is a block diagram of the media player in accordance with an exemplary embodiment of the present disclosure.

FIG. 2 is a shows a relationship table in accordance with an exemplary embodiment that is stored in a storage unit of the media player of FIG. 1.

### DETAILED DESCRIPTION

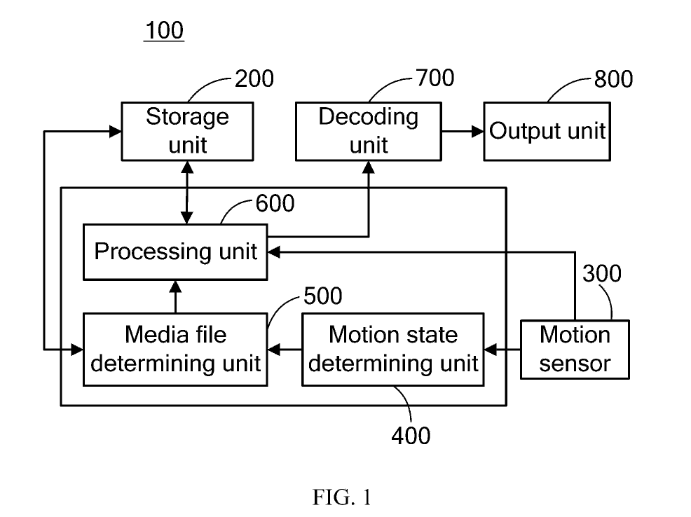

FIG. 1 shows a block diagram of a media player 100 in accordance with an exemplary embodiment. The media player 100 can be a personal digital assistant or a cellular phone. The media player 100 includes a storage unit 200, a motion sensor 300, a motion state determining unit 400, a media file determining unit 500, a processing unit 600, a decoding unit 700, and an output unit 800.

The storage unit 200 stores at least one group of audio files, such as MP3 type music files. The at least one group of audio files are associated with each other, for example, each of the audio files has a common prefix in their file names, such as song 1_{—}1.mp3, song 1_{—}2.mp3, song 1_{—}3.mp3 and etc.

Each of the files in one group has the same content, such as the same song, but at different sampling rates. An original audio file is first obtained and then a plurality of audio files can be created using a sampling rate conversion tool that is capable of converting the sampling rate of the original audio file to any of several different values.

In the present embodiment, the at least one group of audio files have sampling rates ranging from 32 kHz to 8 kHz. At different sampling rates, the audio files differ in their sound quality when being played back. Listeners may prefer different sampling rates at different times according to their moods or the kind of file being played for example. By providing easily selectable sampling rates, another dimension of entertainment is provided to users.

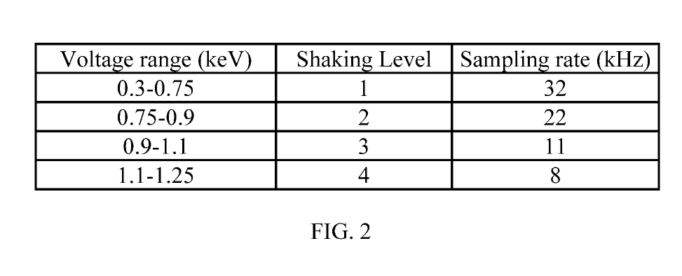

The storage unit 200 also stores a table which defines a relationship between shaking levels of the shaking of the media player 100 and the sampling rates of the at least one group of media files. The shaking level is a parameter indicating how strongly the media player 100 is shaken. Specifically, the more strongly the media player 100 is shaken, the higher the shaking level is. As shown in FIG. 2, each of the shaking levels corresponds to one sampling rate. In this embodiment, the higher the shaking level, the lower the corresponding sampling rate.

In an exemplary embodiment, the motion sensor 300 is an acceleration sensor and is used for detecting acceleration value of the shaking of the media player 100. The acceleration value, as used herein, refers to the absolute value of acceleration. The acceleration of the shaking of the media player 100 may be positive or negative depending on the shaking direction of the housing 900 and the installation position of the acceleration sensor 300. The outputs of the acceleration sensor 300 are voltage signals.

As shown in FIG. 2, in an exemplary embodiment, the table also defines that each of the shaking levels corresponds to one predetermined range of voltages values of the motion sensor 300. In other words, a plurality of acceleration values may correspond to a same shaking level. In order to obtain different shaking levels, it is operable to shake the media player 100 with the varying of the acceleration values of the media player 100.

The motion state determining unit 400 detects signals from the motion sensor 300 in a predetermined time period, such that the shaking level of the shaking of the media player 100 can be monitored.

When the media player is shaken and one of the audio files is playing, the media file determining unit 500 receives signals from the motion state determining unit 400 and determines a sampling rate that corresponds to the shaking level determined by the motion state determining unit 400 The audio file of the current group of audio files from which the current audio file is being played that has the sampling rate determined by the audio file determining unit 500 then becomes the selected audio file.

The processing unit 600 receives signals from the media file determining unit 500 and plays the selected audio file. The selected audio file is played from the location where the previous audio file left off. Specifically, for example, a previous audio file A has been playing for 120 seconds, and a selected audio file B determined by the media file determining unit 500 is then played the point 120 seconds into the file and continues playing the selected audio file B until the shaking level determined by the audio file determining unit changes. As a result, during the shaking of the media player 100, a user can experience content of an audio file at different sampling rates.

While one embodiment has been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A shaking responsive media player comprising:
a motion sensing unit capable of detecting a shaking motion imparted to the media player by a user;
a storage unit storing at least one group of media files associated with each other having same contents and different sampling rates and a table defining relationships between shaking levels of the shaking motion and the sampling rates of the at least one group of media files;
a motion state determining one of the shaking levels of the shaking motion according to signals from the motion sensing unit;
a media file determining unit, wherein when a first media file of the at least one group of media files is playing, the media file determining unit determines a second media file associated with the first media file having the sampling rate corresponding to the shaking level determined by the motion state determining unit according to the table; and
a processing unit playing the second media file until the shaking level determined by the motion state determining unit changes.

2. The shaking responsive media player according to claim 1, wherein the motion sensing unit is an acceleration sensor.

3. The shaking responsive media player according to claim 2, wherein the shaking levels of the media player is determined by acceleration values of the shaking motion.

4. The shaking responsive media player according to claim 1, wherein the sampling rates of the at least one group of media files range from 32 kHz to 8 kHz.

5. The shaking responsive media player according to claim 1, wherein the media player is one of a personal digital assistant and a cellular phone.

6. The shaking responsive media player according to claim 1, wherein the second media file is played from the location where the first media file left off.
